(19) United States
(12) Patent Application Publication
(10) Pub. No.: US 2014/0297014 A1
(43) Pub. Date: Oct. 2, 2014

(54) THREE-DIMENSIONAL OBJECT FABRICATION USING AN IMPLICIT SURFACE REPRESENTATION

(71) Applicant: Microsoft Corporation, Redmond, WA (US)

(72) Inventors: Kristofer N. Iverson, Redmond, WA (US); Christopher C. White, Seattle, WA (US); Yulin Jin, Redmond, WA (US); Jesse D. McGatha, Sammamish, WA (US); Shahram Izadi, Cambridge (GB)

(21) Appl. No.: 13/925,799

(22) Filed: Jun. 24, 2013

Related U.S. Application Data
(60) Provisional application No. 61/806,909, filed on Mar. 31, 2013.

(51) Int. Cl. G05B 19/4099; G06F 17/50

(52) U.S. Cl. CPC G05B 19/4099; G06F 17/50
USPC 700/98; 700/119

(57) ABSTRACT

The subject disclosure is directed towards three-dimensional object fabrication using an implicit surface representation as a model for surface geometries. A voxelized space for the implicit surface representation, of which each machine addressable unit includes indirect surface data, may be used to control components of an apparatus when that apparatus fabricates a three-dimensional object. Instructions generated using this representation may cause these components to move to surface positions and deposit source material.

### CROSS-REFERENCE TO RELATED APPLICATION

The present application claims priority to U.S. Provisional Patent Application Ser. No. 61/806,909, filed Mar. 31, 2013.

### BACKGROUND

A variety of three-dimensional fabrication techniques have been devised to support rapid prototyping from computer models. There are a number of devices capable of fabricating a three-dimensional (3D) solid object of virtually any shape from a digital model. These devices may be referred to as three-dimensional (3D) manufacturing or fabrication devices, such as three-dimensional (3D) printers, Computer Numerical Control (CNC) milling machines, and/or the like.

Some devices employ an enclosed three-dimensional (3D) mesh to model the three-dimensional solid object. Such a mesh may be a mathematical representation of the object's surface. Constructing 3D meshes consumes substantial computational resources. As one reason, conventional algorithms (e.g., Marching Cubes) employed by these printers utilize considerable storage space and processing power. Before figuring out how to transform a 3D mesh into a 3D object, the device may perform a set of operations verifying that the 3D mesh is able to be manufactured. One example printer, for instance, ensures that the 3D mesh is water-tight, devoid of non-manifold edges, and/or not self-intersected. Fixing any one of these issues often is problematic and can lead to inconsistencies with the 3D mesh.

To convert an explicit representation of the object's 3D mesh into machine instructions for fabricating the object, it may be necessary to compute an intersection of a horizontal plane with a surface of the mesh. This may be known as the intersection step. A software/hardware component of the device translates intersecting points into one or more geometric shapes composed of lines and/or curves in a two-dimensional (2D) plane, which may be referred to herein as geometric figures. There often is a loss in precision because of this translation. Some devices also translate geometric figures into machine instructions (e.g., GCode) configured to generate an actual output for each layer. There is a reduction in performance associated with this approach, particularly with the intersection calculation. This approach also results in stability problems, for example, when calculating the intersection between two triangular meshes due to rounding errors associated with floating point values.

To speed up the process of model building and slicing, 3D meshes are often simplified and reduced according to a polycount (e.g., a number of polygons). This simplification reduces the overall fidelity of the model compared to an original representation.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards an implicit approach for improving overall performance/accuracy when fabricating a three-dimensional (3D) object. One example implicit surface representation includes a voxelized address space in which one or more machine addressable units also include surface measurements and/or other surface data. A surface may be represented indirectly by a series of points in which each point indicates a distance from an object's surface, as opposed to an explicit representation, such as a 3D mesh. Each point's distance may be determined using sensors, including scanning devices, which are capable of determining distance as a measure of where the object is located in a two-dimensional space or a three-dimensional space.

In one aspect, a series of straight line operations between some points defines a surface geometry for the object. In another aspect, the implicit surface representation described herein is suitable for generating curves along the surface geometry. In either aspect, a fabrication device may be configured with instructions, which when executed, move one or more printing tools according to the above surface geometry.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an example apparatus for fabricating three-dimensional objects according to one or more example implementations.

FIG. 2 illustrates an example voxelized address space comprising an implicit surface representation corresponding to a three-dimensional object according to one or more example implementations.

FIG. 3 illustrates an example level of an example voxelized address space according to one or more example implementations.

FIG. 4 illustrates an example curve generated between points of a voxelized address space according to one or more example implementations.

FIG. 5 illustrates an example three-dimensional object to be fabricated according to one or more example implementations.

FIG. 6 is a block diagram illustrating an example system for preparing a scanned object for fabrication according to one or more example implementations.

FIG. 7 is a flow diagram illustrating example steps for generating an instruction set for a fabrication device according to one or more example implementations.

FIG. 8 is a flow diagram illustrating example steps for fabricating a three-dimensional object according to one or more example implementations.

FIG. 9 is a flow diagram illustrating example steps for scanning a three-dimensional object according to one or more example implementations.

FIG. 10 is a block diagram representing example non-limiting networked environments in which various embodiments described herein can be implemented.

FIG. 11 is a block diagram representing an example non-limiting computing system or operating environment in which one or more aspects of various embodiments described herein can be implemented.

### DETAILED DESCRIPTION

Various aspects of the technology described herein are generally directed towards managing three-dimensional object fabrication in an apparatus configured with instructions generated from an implicit surface representation for the object being fabricated. With the implicit representation of an object's surface in an address space, one example implementation omits one or more conventional mesh model steps (e.g., an intersection step) because the object's surface is already defined in a machine addressable data structure, which reduces an overall computation time and introduces less or no flaws.

According to one example implementation, by employing a “voxelized” address space, it is appreciated that a set of voxels may model substantially continuous exterior and/or interior surfaces of an object. Each voxel represents an addressable unit of a volumetric three-dimensional address space that stores an accurate distance to a surface position/point as a signed value; whereby, a positive valued voxel represents a pixel location outside of the surface and a negative valued voxel represents a pixel location beneath the surface of the object itself. A position in between differently-signed adjacent voxels represents a true, implicitly-defined surface of the object. A distance to that surface position may be interpolated using the signed positive value and the signed negative value and, as an option, stored in the voxel as a surface measurement.

The implicit surface representation may be modified to be compatible with fabrication devices of different capabilities. Cleanup and repair operations may be bypassed with this approach, thereby further improving performance and guaranteeing an accurate print of an original model. In certain instances, printing curves reduce a frequency of starting and stopping of motors, improving overall print speed and/or utilize print material more efficiently.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and three-dimensional object fabrication in general.

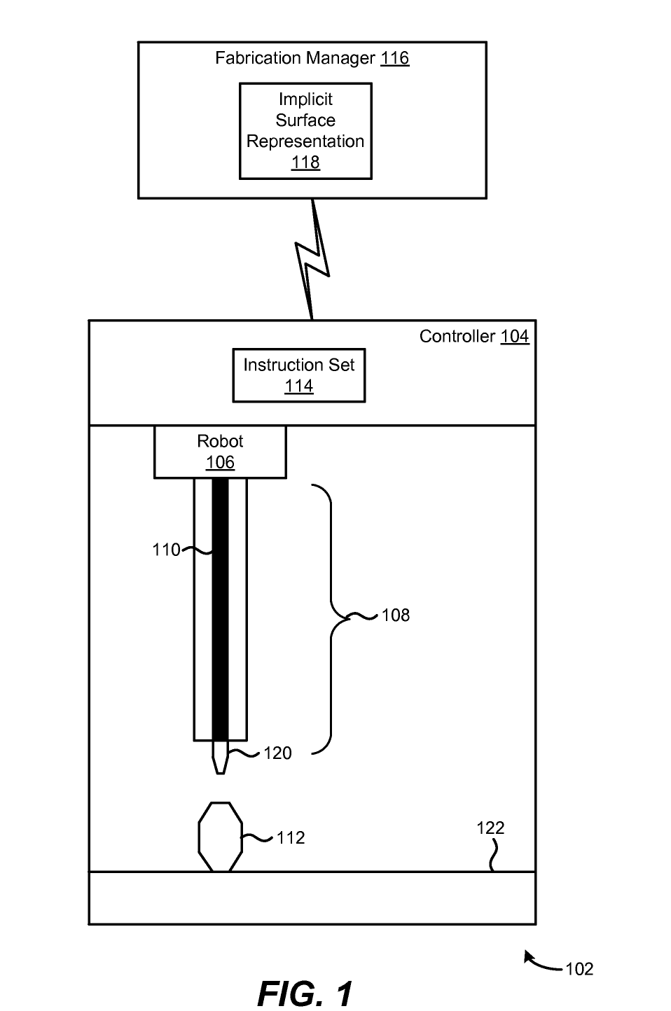

FIG. 1 is a block diagram illustrating an example apparatus for fabricating three-dimensional objects according to one or more example implementations. The following description refers to components that may be implemented in the example apparatus depicted in FIG. 1. Embodiments of these components may be considered hardware, software and/or mechanical in nature. It is appreciated that the example apparatus may be referred to as a fabrication device 102.

One example component of the fabrication device 102 includes a control unit or controller 104 coupled to one or more robotic mechanisms, such as a robot 106, and configured to execute instructions for the robot 106 and a printing mechanism 108. A chamber 110 constructed within the printing mechanism 108 allows source material(s) to be prepared (e.g., heated) and/or blended when fabricating an object 112. For example, the chamber 110 enables melting, mixing, and extruding of one or more filaments, including color filaments.

The robot 106 may include a gantry comprising various mechanical and/or electro-mechanical components. By executing at least some instructions within an instruction set 114, the robot 106 may actuate these components into performing at least some physical movement. When actuated, for example, these components may move horizontally, vertically, diagonally, rotationally and so forth. One example implementation of the robot 106 moves a printing tool across an x, y or z-axis in order to deposit material at a specific position on the object 112 being fabricated. That position may correspond to a machine addressable unit and indirect surface data, such as a surface measurement/distance from a front face of that unit.

The printing mechanism 108 may include to one or more printing tool heads. Although the printing mechanism 108 may resemble an extruder configuration (e.g., a single extruder head configuration), it is appreciated that the printing mechanism 108 represents any compatible technology, including legacy printing tool heads. Furthermore, the printing mechanism 108 may include printing tool heads configured to deposit other materials in addition to colored materials and/or transparent materials. As such, the printing mechanism 108 may include a second chamber and a second nozzle that provides another material (e.g., a polymer) when printing certain structures during fabrication, such as support structures, purge structures and/or the like. Purge structures may refer to areas of the object's model where unusable colored material is deposited. As one example, leftover transitional material in the chamber 110 may be deposited in the purge structure.

Determining a surface geometry for the object 112 may involve a fabrication manager 116 configured to transform indirect surface data within an implicit surface representation 118 into the instruction set 114 mentioned above. One example implementation of the implicit surface representation includes machine addressable units in an address space. These units may be volumetric by definition and therefore, may be referred to as a collection of voxels (e.g., volumetric pixels) that include various data, such as colors, measurements, and/or the like. One example voxel indicates a location of at least some points along the surface geometry, which may be achieved indirectly by storing an accurate distance to one of these surface points as a signed value; whereby, a positive valued voxel represents a pixel location exterior to the surface geometry and a negative valued voxel represents a pixel location interior to the surface geometry.

According to one example implementation, the fabrication manager 116 defines the surface geometry by identifying groups of voxel units in which positive valued voxels are adjacent to negative valued voxels. At least one surface point most likely exists in a volume comprising at least a portion of these voxel units. For each pair comprising a positive voxel and a neighboring negative voxel, as an example, the fabrication manager 116 interpolates these values in order to estimate a surface point's distance and using that estimate, determine a position on the surface geometry.

Because the implicit surface representation 118 is suitable for editing, the fabrication manager 116 may modify such surface data and change surface measurements prior to fabrication. The surface measurements are not connected; and thus, one example technique involves connecting each surface position and producing geometry in a two-dimensional plane comprised of a substantially pixelated outline of straight lines. Other implementations generate curves for smooth and/or fast three-dimensional prints.

One example implementation of the fabrication manager 116 is configured to generate the instructions mentioned above, which when executed by the controller 104, actuate components of the robot 106 resulting in movement(s) of the printing mechanism 108 along a surface geometry (e.g., exterior/interior shell) of the object 112. These instructions may direct the robot 106 to a position corresponding to an approximate surface point on the surface geometry. At this position, these instructions may cause the printing mechanism 108 to deposit material.

Unlike conventional 3D meshes, for instance, the implicit surface representation 118 enables three-dimensional object fabrication without checking for water tightness, manifoldness, self-intersection/overlapping, and/or holes. This may be accomplished by applying a minimum volume to the surface of the object that has a size substantially equal to an output resolution of the fabrication device 102. The minimum volume may be specified by the fabrication manager 116 and/or the controller 104 at the time of printing.

One example implementation may fill the object by, implicitly or algorithmically, closing the object's model. By way of an example, consider an implicit substantially C-shaped surface geometry. One example implementation produces the implicit surface presentation 118 for just the C-shaped shell. Another example implementation may close and/or fill the implicit surface presentation 118 either implicitly, by connecting the ends of the C-shaped surface geometry, or algorithmically, by casting a radial ray from one end of the C-shaped surface geometry to every other point on the surface geometry in order to identify the area “inside” the C-shaped surface geometry to be filled without having that area bulge out of the C-shaped surface geometry.

One example implementation applies data compression to the implicit surface representation 118, reducing an amount of memory used for representing an object. For instance, an interior of the object may be substantially hollow in which instance the fabrication manager 116 applies a compression algorithm, such as n-branch fixed depth octree compression, DEFLATE or a variant, such as LZ77+Huffman coding. Combining any of the compression techniques described herein reduces memory consumption associated with the implicit surface representation and in some instances, produces file formats smaller than simple file formats representing three-dimensional mesh models (e.g., STL files).

Optionally, a movable platform, such as a platform 122, functions as a mechanism that can be directed to surface positions using the implicit surface representation 118. The robot 106 may operate the platform 122 to guide the object 112 to the nozzle 120 or, alternatively, guide the object 112 and the nozzle 120 to each other. The instruction set 114 may include instructions for automatically calibrating the platform 122 in which through a series of movements, for example, in an x, y and/or z direction, the three-dimensional object 112 is moved to a correct position for the nozzle 120 to deposit material.

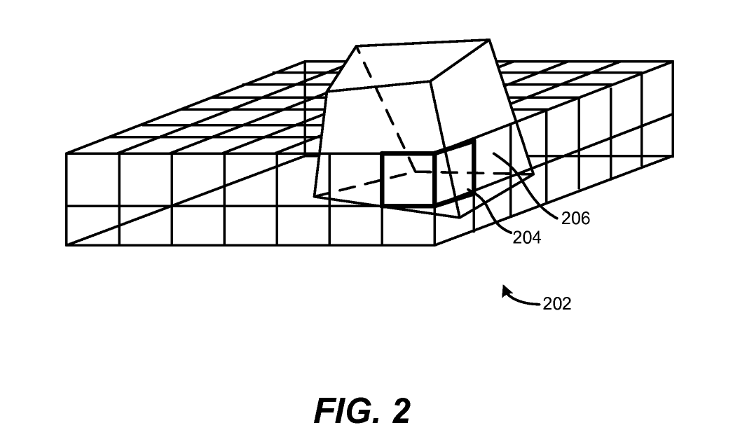

FIG. 2 illustrates an example voxelized address space comprising an implicit surface representation corresponding to a three-dimensional object according to one or more example implementations. The example voxelized address space is depicted in FIG. 2 as an address space 202. The address space 202 can be considered voxelized because each addressable unit represents a volumetric pixel comprising indirect surface data. As an example, voxel data for a unit 204 stores an approximate distance from a portion of the object's surface comprised within the unit 204 and a reference point in the unit 204. This surface distance may be represented as a signed value. The reference point may be a point/position on a front face of the unit 204, but it is appreciated that any point can be established as a reference point. Because the reference point of the unit 204 is located exterior to the object, the surface distance may be a positive value. In contrast, a unit having a reference point located within the object or “beneath” the object surface, such as a unit 206, stores a negative value as an approximate distance from the object's surface located in the unit 204 to a reference point in the unit 206, such as the front face. By way of example, if the surface distance for the unit 206 is −0.2 millimeters and the surface distance for the unit 204 is +0.6 millimeters, an indirect estimate for a surface point's position may be interpolated as +0.2 millimeters, which is a midpoint between the surface distances for the unit 204 and the unit 206. It is appreciated that other embodiments interpolate the surface point's position using additional factors.

The voxel data for the unit 204 optionally may store additional surface measurements that enhance the determination of the surface geometry. One example measurement includes a set of depth measurements from different camera angles. Another example measurement includes a geometric element or vector corresponding to the surface geometry. Voxel data for the unit 204 also may include lighting information, such as luminosity data, specular refraction/diffuse refraction ratios/reflection ratios and/or the like. In yet another implementation, the voxel data for the unit 204 may include color information, such as cyan, magenta, white, yellow, and black.

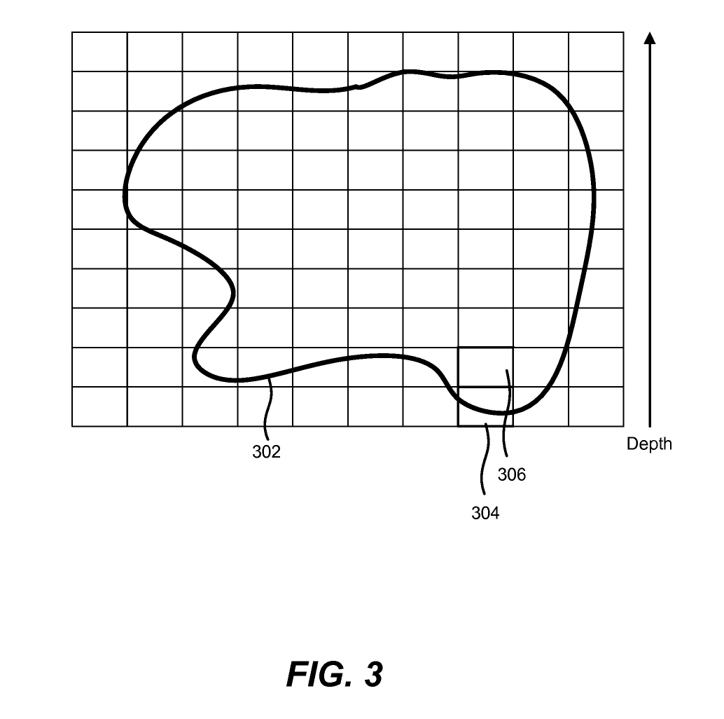

FIG. 3 illustrates an example level of an example voxelized address space according to one or more example implementations. The example level is a three-dimensional volume represented as a two-dimensional plane formed across an x-axis and a y-axis. The plane is partitioned into a grid representing machine-addressable elements or units. Each unit within the grid may represent a machine addressable instance of indirect surface data that is derived from a volumetric pixel. Stacking these planes along a Z-axis may form a volumetric cube encompassing a three-dimensional object. Using certain data structures, such as a three-dimensional array, the voxelized address space is machine addressable in Z-levels. As described herein, each addressable unit of the address space may or may include a portion of the three-dimensional object.

A surface geometry 302 is represented as an enclosed area indicating a surface of the object. Within this area, surface measurement data for a voxel indicates that voxel's distance to positions along the surface geometry 302. It is appreciated that the voxel's distance may not be a planar distance but rather the least distance to the surface geometry 302 in three dimensions. The distance may be a signed floating point value indicating a distance from a point (e.g., a nearest point) on the surface geometry 302 to a face (e.g., a front face) of the voxel. The distance also may include a vector indicating a direction from the point and towards the voxel. This allows the surface geometry 302 of the object to be defined precisely (at least to an acceptable precision) in between voxels, for example, when measured from one side of the object. This representation may be enhanced by storing measurements from multiple directions in the voxel.

By way of example, if a voxel 304 comprises a surface measurement of +0.7 millimeters and a voxel 306 comprises a surface measurement of −0.3 millimeters, it is likely that the object surface lies in one or more positions between these measurements. To estimate at least one surface position, the surface measurements for the voxel 304 and the voxel 306 may be averaged to produce a potential surface position of +0.5 millimeters. This surface position may be assumed to be approximately located at the center of the voxel 306.

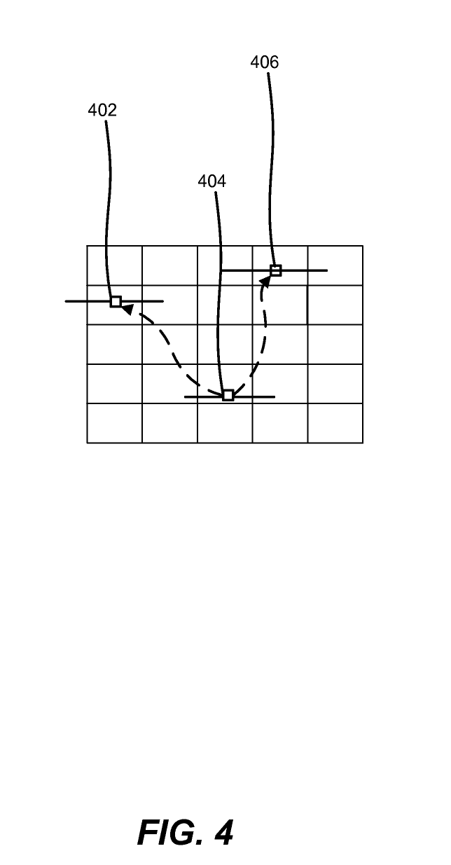

FIG. 4 illustrates an example curve generated between points along a surface according to one or more example implementations. As described herein, surface data may be indirectly represented using surface measurements, such as a surface distance, in a voxelized address space.

A series of perpendicular planes (visualized as straight lines in FIG. 4) define an area or geometry upon which each voxel's data indicates the surface to lie. For each group of three points along the perimeter of the object's surface, using two immediate neighbor points to a central point, one example implementation defines a bisecting line for each angle. Along a perpendicular line to the bisecting line that is also tangential to the point in question, a set of control points is defined for the curve at a distance proportional to half a distance to the neighboring point in that point's direction. These control points, along with defined surface points, when repeated around the entire perimeter of the implicit surface, may fully describe a set of smooth cubic Beziér curve segments in a geometry that passes through each measured point of the implicit surface representation. Computing and printing smooth curves improves overall print speed and print quality. This approach may be applicable to both computations in the two-dimensional plane as well as computations of surface geometry when arranged across the Z plane.

One or more hardware/software components (e.g., the partition manager 116 of FIG. 1) compute a smooth curve between two or more points as depicted in FIG. 4 by a dashed curve. According to one example implementation, generating the curve may involve three (3) or more points corresponding to a surface position 402, a surface position 404 and a surface position 406, as depicted in FIG. 4 by white squares. Using two (2) of these points at a time, the example implementation defines a sequence of lines along the perimeter of the surface. Defining control points between the surface position 404 and the surface position 406, for instance, allows a curve to be fitted. These curves are assembled into a Beziér spline describing a complete or near-complete geometric representation of the surface.

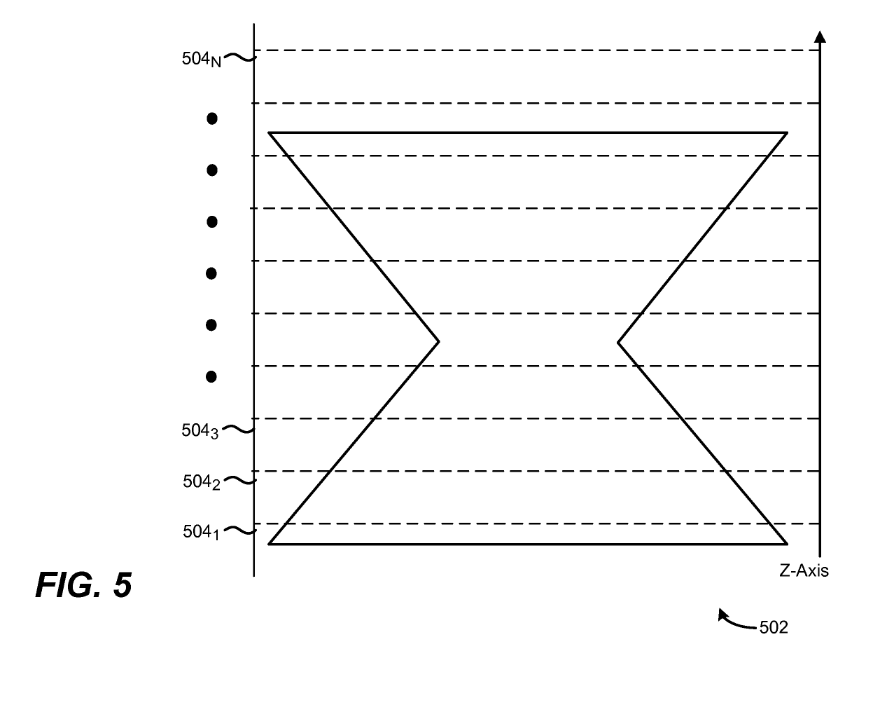

FIG. 5 illustrates an example three-dimensional object to be fabricated according to one or more example implementations. Although the example three-dimensional object being illustrated in FIG. 5 may resemble a vase 502, the following description applies to any three-dimensional object. As described herein, the vase 502 is modeled as a voxelized address space comprised of indirect surface data and arranged into levels. Levels generally refer to the Z-levels of the voxelized address space, as described herein, whereas layers are defined based upon the example apparatus's physical output capabilities after any scaling is applied to the indirect surface data. In some instances, is may be desirable to preserve an original scale for the vase 502 as established by a volumetric sensing apparatus. Accordingly, a layer's height may be less than one (1) level, equal to one (1) level, or greater than one (1) level.

An example apparatus, as described herein, fabricates the vase 502 in a series of layers 504 (layer 504₁ . . . layer 504_{N}) along a z-axis, printing one layer at a time. As described herein, the vase 502 may be implicit represented using a voxelized address space comprised of surface (geometry) measurements. Processing each level of the voxelized address space may involve determining a physical output layer height resolution corresponding to a level height. Some implementations may establish the layer height resolution as a single level, multiple levels or any portion thereof. The resolution may be pre-defined, dynamically computed prior to each fabrication and/or calibrated during the fabrication.

One example resolution may be defined as a minimum extrusion width/volume. The layer height may be set according to that volume. In order to fabricate a first layer 504₁ according to the example resolution, the implicit surface representation is partitioned into levels in which a first level's indirect surface data enables precise movement to surface positions. A robotic mechanism within the apparatus may be directed to these surface positions where a printing tool deposits material. To fabricate a second layer 504₂, a second level's indirect surface data may be transformed into accurate instructions for actuating the robotic mechanism according to the second level's surface geometry. Such a fabrication process may continue until a last layer 504_{N}.

In some example implementations, the implicit surface representation is transformed (e.g., scaled) prior to fabrication. To illustrate one example, a user may direct a sensing apparatus to scan the object and then, enlarge or reduce the indirect surface data by a certain factor. Furthermore, fabricating each subsequent layer may utilize the same layer height resolution or may establish a new layer height resolution. As such, a layer height resolution may be set to multiple levels and/or a portion of a level of the voxelized address space. Data from other levels may be used to divide the indirect surface data into components for each layer. A surface measurement may be partitioned into two component measurements for one layer and another layer when a single level corresponds to two layers. These measurements may be adjusted using surface measurements from an upper level and/or a lower level. In some example implementation where a single level of the implicit surface representation is scaled up to be greater than the physical output layer height resource, a vertical smoothing technique may be employed such that the output layer's indirect surface measurements are interpolated to provide a substantially non-stairstep transition between scanned layers in the fabricated object. Alternatively, surface measurements from multiple levels may be merged (e.g., averaged) for fabricating a single layer. When three levels correspond to one layer, for instance, each unit's surface measurements across the z-axis may be combined into a single composite measurement for that layer.

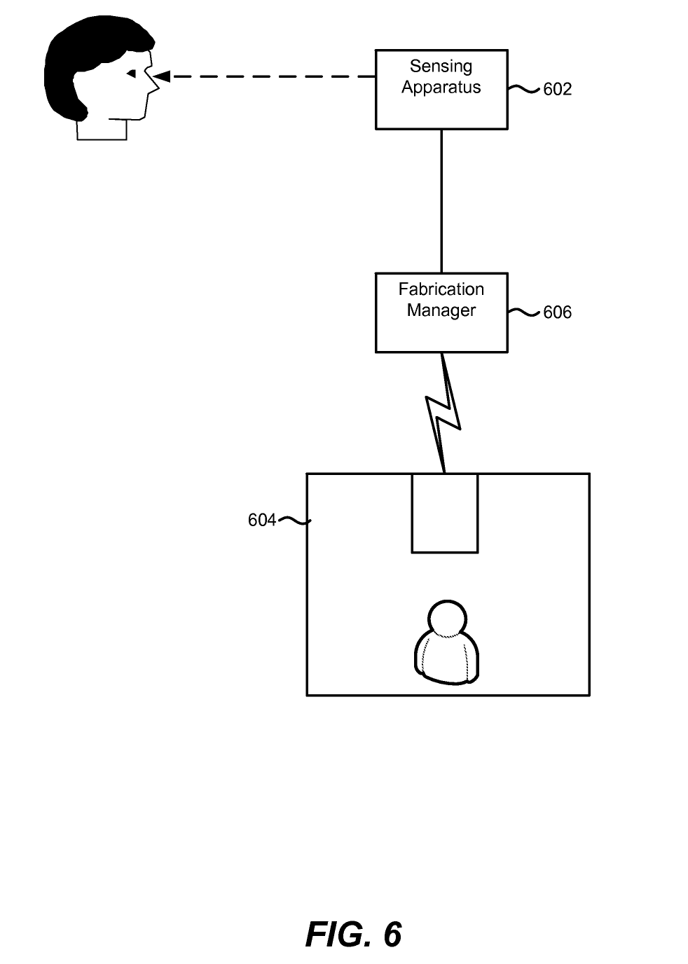

FIG. 6 is a block diagram illustrating an example system for preparing a scanned object for fabrication according to one or more example implementations. Example components of the example system include sensing apparatus 602 and a fabrication device 604 between which a fabrication manager 606 is configured to prepare and control fabrication of scanned three-dimensional (3D) objects.

Regarding the sensing apparatus 602, a number of sensors contribute to building an implicit representation of a model for fabricating the three-dimensional (3D) objects. Each sensor, in conjunction with software, detect changes in state, such as motion, and as such, may be employed by the example component to capture volumetric sensor data, including indirect surface data. There are a number of capable sensors, such as a time-of-flight (TOF) camera employing laser pulses, depth sensors, and/or Red-Green-Blue (RGB) cameras, for obtaining such data. Data from these sensors, using a stereographic analysis, permit reconstruction of a camera angle to measure surface distance and produce the indirect surface data.

An example software/hardware component associated with the sensing apparatus transforms the indirect surface data into a voxelized address space comprising addressable units for surface geometry. Such a representation may be constructed from surface distance measurements and/or a three-dimensional mesh model. In order to enable such a construction of the voxelized address space, the software/hardware example component may provide functionality for generating and/or accessing the indirect surface data. To illustrate one example embodiment, Microsoft® Kinect™-based technology exposes an Application Programming Interface (API) providing software applications with direct access to this data.

As illustrated, the sensing apparatus 602 provides the fabrication manager 604 with the voxelized address space, possible with requests detailing how the object is to be fabricated. The fabrication manager 604 may transform the voxelized address space as directed by the user. In one example embodiment where the fabrication manager 604 monitors the object being scanned, the fabrication manager 604 updates the indirect surface data with additional surface measurements.

The implicit surface representation described herein enables differently configured fabrication devices to print the object from any object model, including mesh models. For example, after scanning an object using the sensing apparatus 602, a first device prints the object locally. The same implicit surface representation may be communicated to another device (e.g., a commercial grade printer) configured to producing the same object but of different quality. In some instances, the other device may produce a higher quality object because that device is capable of matching, one-to-one, the fine resolution of the implicit surface representation. Moreover, the implicit surface representation may be transformed to be compatible with any device's capabilities.

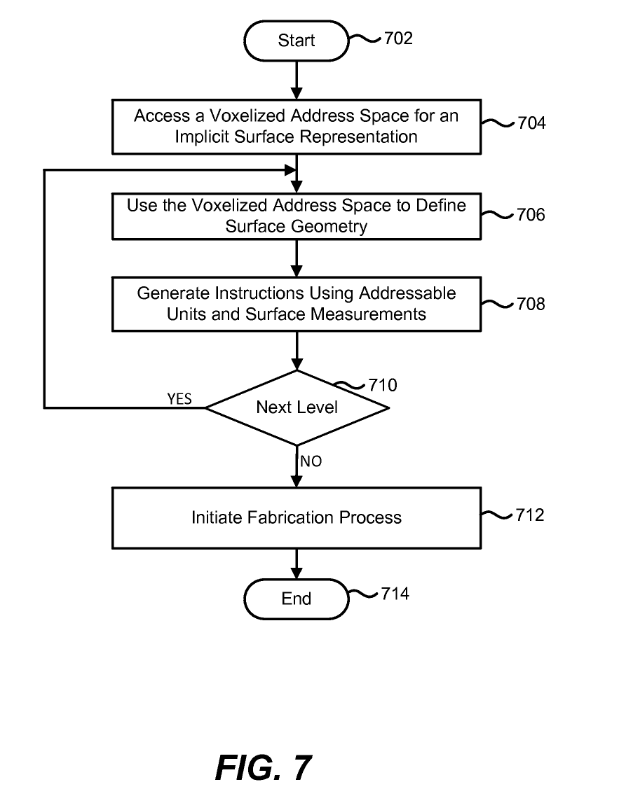

FIG. 7 is a flow diagram illustrating example steps for generating an instruction set for a fabrication device according to one or more example implementations. One or more hardware/software components (e.g., the fabrication manager 116 of FIG. 1) may be configured to perform the example steps. Step 702 commences the example steps and proceeds to step 704 where a voxelized address space for an implicit surface representation is accessed.

Step 706 uses the voxelized address space to define surface geometry. As described herein, the voxelized address space is comprised of levels in which each levels includes machine addressable units across a two-dimensional plane. Each unit's voxel address refers to a specific volume comprising at least a portion of a three-dimensional object. Each unit comprises a surface measurement corresponding to a distance to a surface position. Connecting surface positions may form line segments, curves, polygons and/or other surface geometry.

Step 708 is directed to generating instructions for applying material at positions along the object's surface geometry and/or for any support structures inside or outside of the object. One example implementation configures these instructions for execution by the fabrication device, as described herein. An example instruction may include a three-dimensional coordinate set and commands directing a robot to the three-dimensional coordinate set and causing one or more printing tools to deposit source material. Step 710 determines whether there is a next level for which instructions are to be generated. If there are one or more levels remaining in the implicit surface representation, step 710 returns to step 706. If there are no more levels of indirect surface data, step 710 returns to step 706. Step 712 initiates a fabrication process by communicating the instructions to the fabrication device, which executes the instructions and starts fabricating the three-dimensional object. Step 712 may continue to monitor the fabrication process until completion after which step 714 terminates the example steps of FIG. 7. It is appreciated that, in another implementation, step 712 may be initiated concurrently with generation of surface geometry when the level height exceeds the height of the next level to fabricate. This may be because (geometric) levels are well-sorted by virtue of being represented in the voxelized address space, which can result in rapid fabrication of the object.

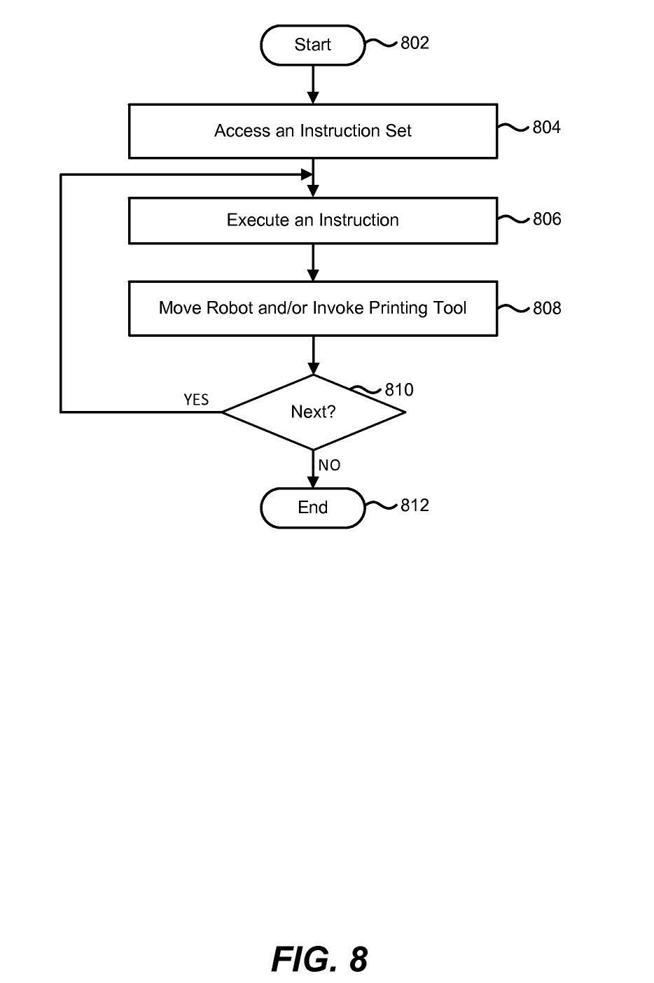

FIG. 8 is a flow diagram illustrating example steps for fabricating a three-dimensional object according to one or more example implementations. One or more hardware/software components of an apparatus (e.g., the fabrication device 102 of FIG. 1) may be configured to perform the example steps. Step 802 commences the example steps and proceeds to step 804 where an instruction set is accessed.

As described herein, a fabrication process may be performed in a series of layers in which each layer corresponds to at least a portion of a level of an implicit surface representation of an object's model. Each level comprises machine addressable units corresponding to a voxel address and a surface measurement in two-dimensional space. Step 806 executes an instruction from the instruction set. One example instruction includes a command specifying a surface position using two-dimensional coordinates and/or other suitable numerical control commands. Another instruction may specify a current layer being fabricated. The example instruction also may include printing tool-specific commands, such as commands that set source material length and/or stepper motor speed, enable/disable material disposition, and/or the like.

As a result of executing the instruction, step 808 moves the robot to the surface position and invokes the printing tool, which deposits source material at that position. Note, when some example embodiments commence material deposition, the printing tool is moved along the surface geometry depositing a trail of material. Other embodiments, such as powder printers, lay down a thin layer of material and then, deposit a fixative and/or apply light or heat to fuse or cure the material. When finished, the object is simply removed from a bed of powder. Yet other embodiments, such as a stereolithography printing, uses light to cure a resin one layer at a time. Each layer is “flashed” at once or sequentially to cure the resin and at the end, the cured object is removed from the resin vat.

Step 810 determines whether there is a next instruction in the instruction set. If there is more surface geometry to fabricate, for instance, step 810 returns to step 806 where a next instruction is executed. If there are no more instructions in the instruction set, step 810 proceeds to step 812. The example steps described in FIG. 8 terminate at step 812, for example, when there are no layers of the object to fabricate.

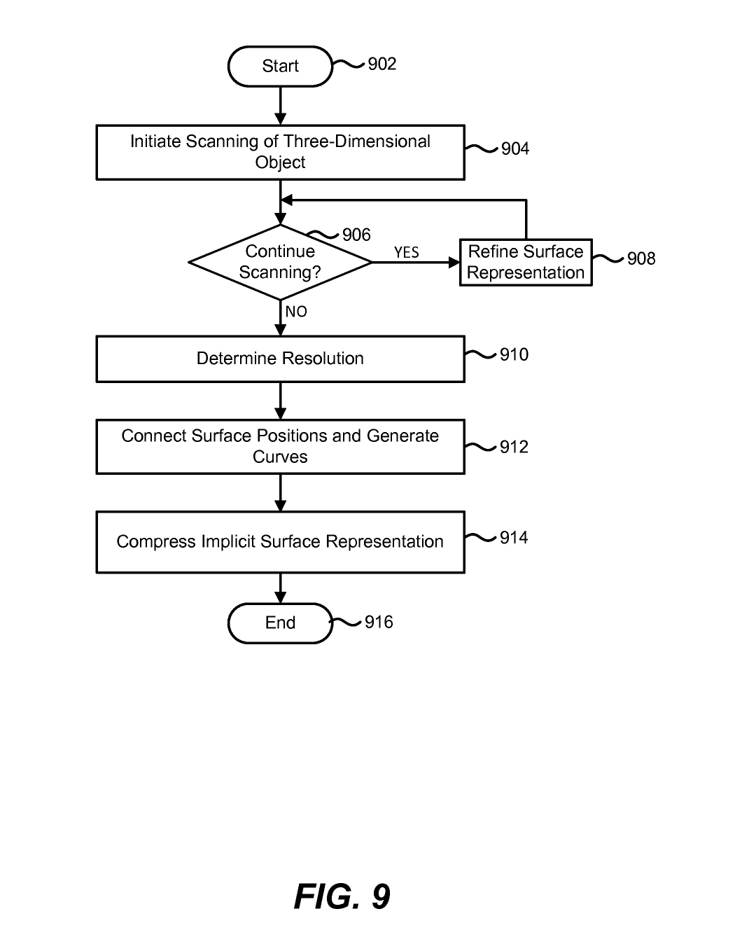

FIG. 9 is a flow diagram illustrating example steps for scanning a three-dimensional object according to one or more example implementations. One or more hardware/software components (e.g., the fabrication manager 906 of FIG. 9) may be configured to perform the example steps. Step 902 commences the example steps and proceeds to step 904, which initiates scanning of a three-dimensional object. Periodically, step 906 determines whether to continue scanning or stop the fabrication process. If the three-dimensional object is not fully scanned, for instance, step 906 proceeds to step 908. Step 908 refines a current state of an implicit surface representation. One example implementation adds surface measurements and/or adjusts other surface measurements through a related statistical analysis. To illustrate one example, as a sensing apparatus captures volumetric sensor data, including depth measurements/surface distances from multiple camera angles, a fabrication manager collects such indirect surface data into a voxelized address space and then, continuously updates units in that space with more precise measurements. Accordingly, previously uncaptured data is scanned and used to enhance the indirect surface data's accuracy, and each additional set of readings incrementally improves the object's model.

When scanning is completed, step 906 proceeds to step 910. Step 910 determines a resolution at which the object is to be fabricated and, if needed, adjust the implicit surface representation accordingly. The resolution may refer to a width of each voxel unit and/or a physical output layer height. A user may have requested that the object be transformed (e.g., scaled across an axis) while maintaining the above resolution. One example implementation adjusts surface measurements of the implicit surface representation to comply with the requested transformation.

When a shell is identified as the surface geometry, by establishing a minimum shell thickness, the implicit surface representation may be used to fabricate the object. The fabrication device may utilize such a minimum shell thickness by performing extrusions, for example, front-to-back with that thickness. This allows, as an example, scanning of all or part of a person's body using sensors and printing a likeness of the person's head having a face mask and an extrusion behind the mask into a freestanding statuette.

As an alternative, step 910 may determine the above described resolution until after the sensing apparatus captures a detailed implicit surface representation (unless configurable by a user to a lower resolution). The implicit surface representation may be fabricated at a different resolution after scaling and/or discarding indirect surface data (if scaling down).

Step 912 generates curves by connecting surface positions into forming surface geometry. One example implementation connects a group of three or more surface positions creating an outer periphery of the object's surface geometry and by using two or more inter-voxel coordinates as control points for defining a curve. As an example, a set of control points is defined at a distance proportional to half a distance to the neighboring surface position in that point's direction. These control points, along with defined surface positions, when repeated around the entire perimeter of the implicit surface, may fully describe a set of smooth curve segments, representing a spline, in a geometry that passes through each measured point of the implicit surface representation.

Step 914 compresses the implicit surface representation using an applicable data compression technique. The implicit surface representation may result in sparse surface data with a substantial number of repetitive surface measurements to an interior and/or an exterior of the object. Some interior points may be omitted if such points are not intrinsic to implicitly defining the surface of the object. Once fully pruned of these points, the surface data may then be compressed. As another example, the surface data can be compressed by forming unused/empty bounding space around a shell of the object and cropping the surface data to define a space fitting at least the size of a three-dimensional space representing the object. Step 916 terminates the example steps depicted in FIG. 9.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

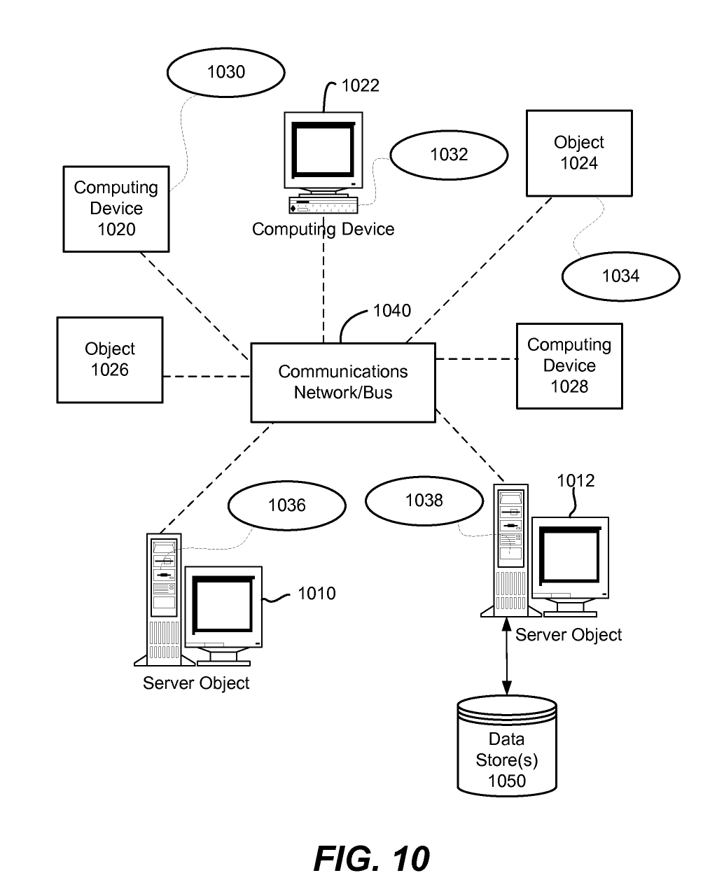

FIG. 10 provides a schematic diagram of an example networked or distributed computing environment. The distributed computing environment comprises computing objects 1010, 1012, etc., and computing objects or devices 1020, 1022, 1024, 1026, 1028, etc., which may include programs, methods, data stores, programmable logic, etc. as represented by example applications 1030, 1032, 1034, 1036, 1038. It can be appreciated that computing objects 1010, 1012, etc. and computing objects or devices 1020, 1022, 1024, 1026, 1028, etc. may comprise different devices, such as personal digital assistants (PDAs), audio/video devices, mobile phones, MP3 players, personal computers, laptops, etc.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1040, either directly or indirectly. Even though illustrated as a single element in FIG. 10, communications network 1040 may comprise other computing objects and computing devices that provide services to the system of FIG. 10, and/or may represent multiple interconnected networks, which are not shown. Each computing object 1010, 1012, etc. or computing object or device 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 1040 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

### Example Computing Device

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 8 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

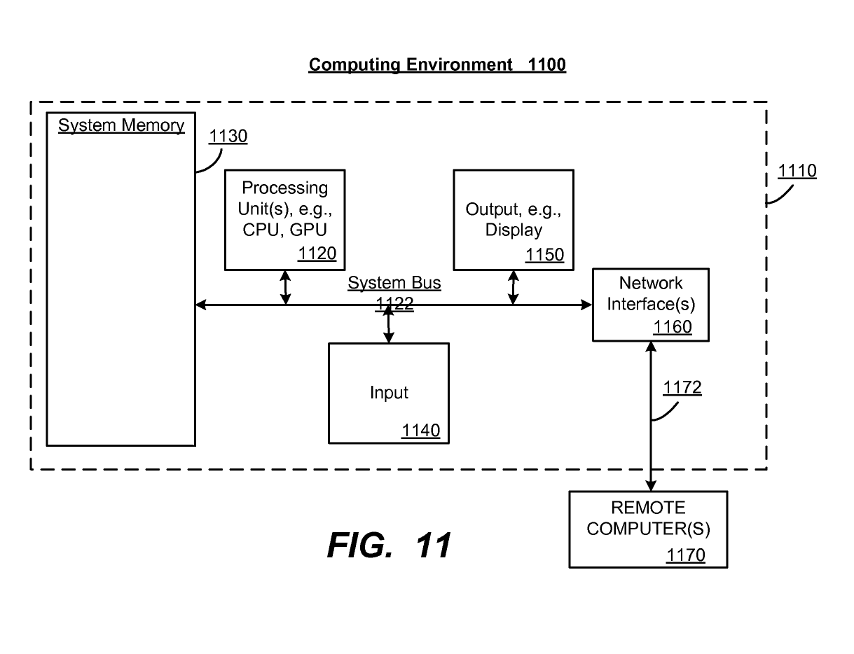

FIG. 11 thus illustrates an example of a suitable computing system environment 1100 in which one or aspects of the embodiments described herein can be implemented, although as made clear above, the computing system environment 1100 is only one example of a suitable computing environment and is not intended to suggest any limitation as to scope of use or functionality. In addition, the computing system environment 1100 is not intended to be interpreted as having any dependency relating to any one or combination of components illustrated in the example computing system environment 1100.

With reference to FIG. 11, an example remote device for implementing one or more embodiments includes a general purpose computing device in the form of a computer 1110. Components of computer 1110 may include, but are not limited to, a processing unit 1120, a system memory 1130, and a system bus 1122 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). By way of example, and not limitation, system memory 1130 may also include an operating system, application programs, other program modules, and program data.

A user can enter commands and information into the computer 1110 through input devices 1140. A monitor or other type of display device is also connected to the system bus 1122 via an interface, such as output interface 1150. In addition to a monitor, computers can also include other peripheral output devices such as speakers and a printer, which may be connected through output interface 1150.

The computer 1110 may operate in a networked or distributed environment using logical connections to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 11 include a network 1172, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, transforming an implicit surface representation of a three-dimensional object into an instruction set configured to fabricate the three-dimensional object, including accessing a voxelized address space corresponding to the implicit surface representation in which at least one unit comprises at least one surface measurement, using the voxelized address space to determine surface geometry for the three-dimensional object, and generating the instruction set for a fabrication device to execute.

2. The method of claim 1, wherein accessing the voxelized address space further comprises accessing volumetric sensor data from a sensing apparatus scanning the three-dimensional object.

3. The method of claim 1, wherein accessing the voxelized address space further comprises in a unit of the voxelized address space, storing a surface distance from a face of that unit.

4. The method of claim 1, wherein using the voxelized address space further comprises generating curves using at least three surface positions on the implicit surface representation and at least two control points.

5. The method of claim 1, wherein using the voxelized address space further comprises connecting a set of surface positions to form at least one an exterior surface or an interior surface.

6. The method of claim 1, wherein generating the instruction set further comprises generating an instruction directing a robot to a surface position corresponding to a voxel address and indirect surface data.

7. The method of claim 1, wherein accessing the voxelized address space further comprises converting volumetric sensor data into levels of the implicit surface representation in which each level comprises into at least a portion of the surface geometry.

8. The method of claim 1 further comprising storing at least one of color information or lighting information in each voxel of the voxelized address space.

9. The method of claim 1 further comprising using a minimum volume for fabricating at least one layer.

10. In a computing environment, an apparatus, comprising, at least one robotic mechanism, and a control unit configured to execute an instruction set configured to fabricate a three-dimensional object, wherein the instruction set is generated using an implicit surface representation, wherein executing the instruction set actuates at least one robotic mechanism, causing a printing tool to deposit at least one material when fabricating the three-dimensional object.

11. The apparatus of claim 10 further comprising a fabrication manager running on a computing device and coupled to the control unit, wherein the fabrication manager is configured to automatically generate instructions for the instruction set, wherein the fabrication manager is further configured to apply a voxelized address space to at least a portion of the implicit surface representation, determine surface geometry from the voxelized address space, and generate instructions for moving a printing tool according to the surface geometry.

12. The apparatus of claim 10, wherein the at least one robot mechanism executes an instruction causing the printing tool to move to location on the surface geometry that corresponds to a unit of the voxelized address space and at least one surface measurement.

13. The apparatus of claim 10 wherein the at least one robotic mechanism comprises a gantry configured to move the printing tool in at least one direction.

14. The apparatus of claim 10 wherein the at least one robotic mechanism comprises a movable platform configured to move the three-dimensional object toward the printing tool.

15. One or more computer-readable media having computer-executable instructions, which when executed perform steps, comprising:
accessing volumetric sensor data associated with a three-dimensional object that comprises an implicit surface representation, including converting the volumetric sensor data into an indirect surface measurement for each voxel in an address space;
refining the implicit surface representation using additional surface measurements; and
communicating the implicit surface representation to an apparatus configured to fabricate the three-dimensional object.

16. The one or more computer-readable media of claim 15 having further computer-executable instructions comprising:
scanning the three-dimensional object using sensing apparatus to generate the volumetric sensor data.

17. The one or more computer-readable media of claim 15 having further computer-executable instructions comprising:
transforming the implicit surface representation, including determining a resolution in which a layer comprises a portion of a level or one or more levels.

18. The one or more computer-readable media of claim 17, wherein if the layer comprises multiple levels, computing an average surface distance using surface measurements from a set of voxels in the multiple levels.

19. The one or more computer-readable media of claim 17, wherein if the layer comprises a portion of a level, computing a surface distance estimate for the portion using surface measurements from at least one adjacent level.

20. The one or more computer-readable media of claim 17 having further computer-executable instructions comprising:
compressing the implicit surface representation prior to fabrication of the three-dimensional object.
